(19) United States
(12) Patent Application Publication
(10) Pub. No.: US 2026/0187471 A1
(43) Pub. Date: Jul. 2, 2026

(54) TRAINING MULTI-MODAL INTERACTIVE AGENTS USING A REWARD MODEL

(71) Applicant: DeepMind Technologies Limited, London (GB)

(72) Inventors: Petko Ivanov Georgiev, London (GB); Federico Javier Carnevale, London (GB); Chia-Chun Hung, London (GB); Jessica Paige Landon, London (GB); Timothy Paul Lillicrap, London (GB); Alistair Michael Muldal, London (GB); Tamara Louise von Glehn, Cambridge (GB); Gregory Duncan Wayne, London (GB); Chen Yan, London (GB)

(21) Appl. No.: 19/131,804

(22) PCT Filed: Nov. 21, 2023
(86) PCT No.: PCT/EP2023/082592

§ 371 Date: May 21, 2025

Related U.S. Application Data
(60) Provisional application No. 63/427,080, filed on Nov. 21, 2022.

(51) Int. Cl. G06N 3/092

(52) U.S. Cl. CPC G06N 3/092

(57) ABSTRACT

Methods, systems, and apparatus, including computer programs encoded on a computer storage medium, for controlling agents. In particular, an interactive agent can be controlled by a neural network trained with reward values using reinforcement learning.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that controls an interactive agent that is interacting in an environment by selecting actions to be performed by the agent and then causing the agent to perform the actions.

The agent is referred to as an “interactive” agent because the agent interacts with one or more other agents in the environment as part of interacting with the environment. The one or more other agents can include humans, other agents controlled by different computer systems, or both. The interactive agent interacts with the other agent(s) by receiving communications generated by the other agent(s) and, optionally, generating text that is communicated to the other agent(s).

In particular, the interactions with the other agents provide information to the interactive agent about what task the agent should be performing in the environment at any given time.

In one aspect, a method performed by one or more computers and for training a policy neural network for controlling an agent interacting with an environment comprises, at each of a plurality of time steps: obtaining an observation for the time step, wherein the observation comprises an image characterizing a state of the environment at the time step and a natural language text sequence for the time step that characterizes a task being performed by the agent in the environment at the time step; processing a policy input comprising the observation image and the natural language text sequence using the policy neural network to select one or more actions to be performed by the agent in response to the observation image; processing a reward input comprising the observation image and the natural language text sequence using a reward neural network, wherein the reward neural network is configured to process the observation image and the natural language text to generate a reward output that defines a reward value that characterizes a progress of the agent in performing the task characterized by the natural language text sequence as of the time step; and training the policy neural network through reinforcement learning using the respective reward values for the plurality of time steps.

In some implementations, prior to training the policy neural network through reinforcement learning, the method comprises training the policy neural network through imitation learning on data characterizing interactions between a plurality of agents in the environment.

In some implementations, the reward neural network is configured to generate reward values that represent a utility to performing the task of a trajectory of observations up to and including the observation for the time step.

In some implementations, training the policy neural network through reinforcement learning using the respective reward values for the plurality of time steps comprises: for each of the plurality of time steps, computing a per-time step reward based on a difference between the reward value at the time step and the reward value for a preceding time step in the sequence; and training the policy neural network through reinforcement learning using the respective per-time step rewards for the plurality of time steps.

In some implementations, the reward input comprises a reward value generated for a preceding time step in the sequence.

In some implementations, the reward input further comprises a natural language output generated by the agent at a preceding time step.

In some implementations, the reward output is the reward value.

In some implementations, the reward output comprises a probability distribution over a set of possible reward values.

In some implementations, the reward neural network has been trained on training data that includes, for each of one or more time steps in each of a plurality of training task episodes, a respective reward label selected from a set of reward labels that includes: a negative reward label that indicates that, as of the time step, the agent regressed from achieving a goal characterized in a natural language instruction for the time step; a positive reward label that indicates that, as of the time step, the agent made progress in achieving the goal characterized in the natural language instruction for the time step.

In some implementations, the reward neural network has been trained on training data that includes, for each of one or more time steps in each of a plurality of training task episodes, a respective reward label selected from a set of reward labels also includes a neutral reward label.

In some implementations, the reward model has been trained on the training data on a loss function that measures differences between reward values predicted for two time steps within the same training task episode.

In some implementations, the reward neural network has been trained on training data and for a given pair of time steps within the same training task episode: if both time steps in the pair have a positive reward label and no time steps that are between the time steps in the pair have a negative reward label, the loss function encourages (e.g. biases or tends to cause) the reward value predicted for a later time step in the pair to be greater than the reward value predicted for an earlier time step in the pair; and if both time steps in the pair have a negative reward label and no time steps that are between the time steps in the pair have a positive reward label, the loss function encourages the reward value predicted for the earlier time step in the pair to be greater than the reward value predicted for the later time step in the pair.

In some implementations, the reward neural network has been trained on training data that includes a given pair of time steps wherein if both time steps in the pair have a neutral reward label and all time steps that are between the time steps in the pair have a neutral reward label, the loss function encourages the reward value predicted for the later time step in the pair to be equal to the reward value predicted for the earlier time step in the pair.

In some implementations, the loss function measures, for each time step in each of the training episodes, an error between the reward label for the time step and the reward value for the time step.

In some implementations, processing a reward input comprising the observation image and the natural language text sequence using a reward neural network comprises: using an image embedding neural network to generate a plurality of image embeddings that represent the observation image; processing an input comprising the natural language text sequence using a text embedding neural network to generate a plurality of text embeddings that represent at least the natural language text sequence; processing an input comprising the image embeddings and the text embeddings using a multi-modal neural network to generate an aggregated embedding; and processing an input comprising the aggregated embedding using a reward neural network head to generate the reward value. That is, the reward neural network head, may comprise one or more neural network layers including an output layer, which are configured to process the input comprising the aggregated embedding such that the output layer generates the reward value.

In some implementations, the multi-modal neural network is a multi-modal Transformer neural network that is configured to (i) apply self-attention over at least the text embeddings and the image embeddings to generate respective updated embeddings for at least the plurality of text embeddings and (ii) generate the aggregated embedding from at least the respective updated embeddings for the text embeddings.

In some implementations, the multi-modal Transformer neural network comprises one or more self-attention layers that each have one or more self-attention heads, and wherein applying self-attention comprises processing the input through the one or more self-attention layers.

In some implementations, the input to the multi-modal Transformer neural network comprises the image embeddings, the text embeddings, and one or more dedicated embeddings (e.g. embeddings that are not dependent on the observation at the time step). In some implementations, applying self-attention comprises generating respective updated embeddings for the text embeddings and the dedicated embeddings without updating the image embeddings.

In some implementations, each self-attention head of each self-attention layer is configured to (i) receive a head input comprising the image embeddings generated by the image embedding neural network and respective current embeddings for the text embeddings and the dedicated embeddings (ii) generate, from the respective current embeddings, a respective query corresponding to each text embedding and each dedicated embedding (iii) generate, from the image embeddings and the respective current embeddings, a respective key corresponding to each image embedding, each text embedding, and each dedicated embedding (iv) generate, from the image embeddings and the respective current embeddings, a respective value corresponding to each image embedding, each text embedding, and each dedicated embedding and (v) apply query-key-value attention over the respective queries, keys, and values to generate a respective initial updated embedding for each text embedding and each dedicated embedding without updating the image embeddings.

In some implementations, generating the aggregated embedding comprises aggregating the respective updated embeddings for the text embeddings and the dedicated embeddings to generate an initial aggregated embedding and combining the respective updated embeddings for the dedicated embeddings with the initial aggregated embedding to generate the aggregated embedding.

In some implementations, the combining comprises concatenating each respective updated embedding and the initial aggregated embedding.

In some implementations, processing an input comprising the aggregated embedding using a reward neural network head to generate the reward output comprises generating a state representation from the aggregated embedding, and processing the state representation using one or more neural network layers to generate the reward output.

In some implementations, generating the state representation comprises processing the state representation using a memory neural network.

In some implementations, the memory neural network is a recurrent neural network.

In some implementations, the reward input further comprises a natural language output generated by the agent at a preceding time step, wherein the input to the text embedding neural network further comprises the natural language output and the text embeddings represent the natural language text sequence and the natural language output.

In some implementations, the natural language text sequence is generated from a natural language text sequence that is generated based on a corresponding natural language text sequence from a corresponding time step in a training task episode.

In some implementations, the natural language text sequence is generated by a setter agent in the environment.

In some implementations, the setter agent is controlled using a setter neural network.

In some implementations, the setter neural network has been trained to imitate an expert setter agent through imitation learning.

In some implementations, the reward neural network has been trained on an overall loss function that includes (i) a loss function that is based on the reward labels and (ii) one or more auxiliary losses.

In some implementations, the one or more auxiliary losses include an imitation learning loss that is computed using output generated by an auxiliary policy neural network head that generates policy outputs for controlling the agent.

In some implementations, the one or more auxiliary losses include a contrastive self-supervised representation learning loss.

In some implementations, the one or more auxiliary losses include a cross-modality matching loss that uses outputs generated by the multi-modal neural network.

In some implementations, at least some of the parameter values of the reward neural network were initialized using parameter values of the policy neural network that were determined by training the policy neural network through imitation learning.

In some implementations, training the policy neural network through reinforcement learning using the respective reward values for the plurality of time steps comprises training the policy neural network through reinforcement learning and through imitation learning on an imitation learning data set.

In some implementations, each observation image is captured by a camera sensor of the agent or a camera sensor located in the environment.

In some implementations, the agent is a mechanical agent that interacts with a real-world environment to accomplish a specified goal (e.g. specified by the natural language inputs) by performing actions selected by the trained policy neural network in response to observations of the real-world environment.

In some implementations, the agent is a software agent configured to control an electromechanical device in a real-world environment to accomplish a specified goal (e.g. specified by the natural language inputs) by performing actions selected by the trained policy neural network in response to observations of the real-world environment.

In some implementations, the environment is a computing environment and the agent is a software agent executing within the computing environment to control, by performing actions selected by the trained policy neural network, one or more computing devices to carry out a task specified by a user interacting with the software agent. For example, the user may specify the task through the natural language inputs, which may be provided by the user in the form of speech and/or text.

Particular embodiments of the subject matter described in this specification can be implemented so as to realize one or more of the following advantages.

This specification generally describes techniques for training a neural network to control an interactive agent to perform tasks that are specified by natural language instructions issued by other agents in the environment.

Controlling such agents can be particularly valuable in many real-life tasks that require an agent to perform a variety of tasks that are described by statements made by other agents, e.g., humans or agents controlled using other policies, rather than tasks that are fixed in advance. However, training data for these types of tasks can be difficult to collect and, due to the open-ended nature of the tasks, cannot encompass the wide variety of tasks that the agent may be instructed to perform after training.

To allow the system to effectively control the agent even with these challenges, this specification describes a variety of techniques that can be used together or separately to improve interactive agent control and to allow the system to effectively control agents to perform new tasks that were not seen in training data.

As one example, this specification describes a neural network (a “perceptual encoder”) that effectively combines multi-modal inputs to generate an encoded representation of the environment. This allows the system to generate accurate representations of environment states that result in more accurate control that better generalizes to new tasks.

As another example, this specification describes a reward neural network that is trained on expert evaluations of agent interactions in an environment to determine whether an agent is performing actions that progress towards a stated objective. A reward neural network is trained to output a reward value, that is used to train the policy neural network using a reinforcement learning technique. For example, the policy neural network can be initially trained using imitation learning and then fine-tuned using the reinforcement learning approach with the outputs of the reward neural network. By making use of the reward neural network, the system can accurately estimate rewards for a wide range of tasks, without being limited to those that have already been performed by an expert agent. Thus, the trained policy neural network can better generalize to new tasks after training.

For example, agents that are trained using only imitation learning may be able to reach a base level of competency. However, agents trained with reinforcement learning, e.g., by fine-tuning after initially being trained through imitation learning are able to reach human levels of competency for many tasks. As will be described in more detail below, such improvements apply both to interactions involving mobile manipulation (environmental locomotion and dexterous physical interaction) as well as tasks involving bidirectional verbal interaction like question-answering.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling the agent at a time step.

FIG. 3 is a flow diagram of an example process for generating an encoded representation at a time step.

FIG. 4 is a flow diagram of an example process for generating a sequence of multiple actions.

FIG. 5 is a flow diagram of an example process for training the policy network with reinforcement learning.

FIG. 6 is a flow diagram of an example process for generating training data to train the reward neural network.

FIG. 7 is a flow diagram of an example process for training the reward neural network.

FIG. 8 is a flow diagram of an example process of training the policy network with reinforcement learning.

FIG. 9 is a flow diagram of an example process of generating a reward value from the reward neural network.

FIG. 10 shows an improvement of an agent directed by a policy neural network with reinforcement learning compared to a policy neural network with only imitation learning. Like reference numbers and designations in the various drawings indicate like elements.

FIG. 11 shows a diagram of an example process of improving a policy neural network with reinforcement learning using outputs of a reward model.

FIG. 12 shows a diagram of an example process training a policy neural network, training a reward neural network, and training the policy neural network on the reward neural network using reinforcement learning.

FIG. 13 shows an example of the data collected for training the reward neural network.

FIG. 14 shows an example algorithm for implementing an “Inter-temporal Bradley-Terry” model to train the reward neural network.

### DETAILED DESCRIPTION

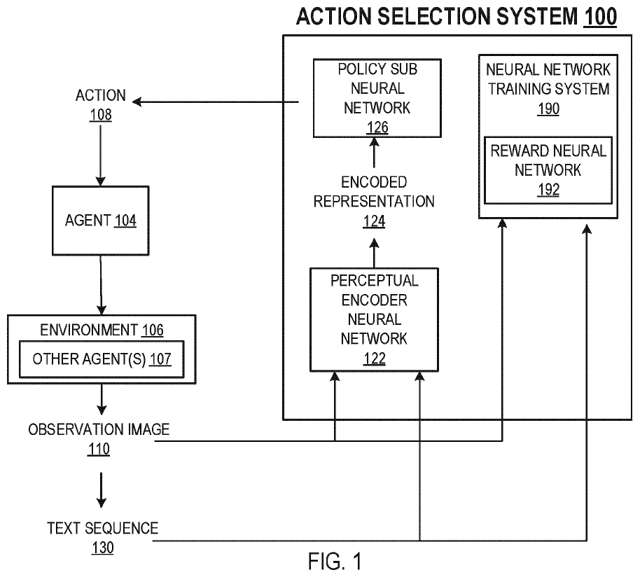

FIG. 1 shows an example action selection system 100. The action selection system 100 is an example of a system implemented as computer programs on one or more computers in one or more locations in which the systems, components, and techniques described below are implemented.

The action selection system 100 controls an interactive agent 104 that is interacting in an environment 106 by selecting actions 108 to be performed by the agent 104 and then causing the agent 104 to perform the actions 108.

In particular, at each time step the system 100 receives a multi-modal input, e.g., an input that includes data of multiple modalities (e.g. data types), that includes at least an observation image 110 that characterizes the state of the environment at the time step and a natural language text sequence 130 and uses the multi-modal input to control the agent 104.

The agent 104 is referred to as an “interactive” agent because the agent 104 interacts with one or more other agents 107 in the environment as part of interacting with the environment. The one or more other agents 107 can include humans, other agents controlled by different computer systems, or both. The interactive agent 104 interacts with the other agent(s) 107 by receiving communications generated by the other agent(s) 107 and, optionally, generating text that is communicated to the other agent(s).

In particular, at each time step, the system 100 receives an observation image 110 characterizing the state of the environment 106 at the time step. The observation image 110 can be, e.g., captured by a camera sensor of the agent 104 or captured by another camera sensor located within the environment 106.

The system 100 also receives a natural language text sequence 130 for each time step. In particular, the natural language text sequence 130 can be a result of a communication from one of the other agents 107 in the environment 106. For example, another agent 107 can speak an utterance (e.g. verbalize or express the utterance audibly) and the interactive agent 104 or the system 100 can transcribe the utterance to generate the natural language text sequence 130.

In some cases, there may not be a new communication at every time step. In these cases, the system 100 can use the most recently received natural language text sequence as the text sequence 130 for the time step. That is, the system 100 can re-use the most recently received natural language text sequence until a new text sequence is received.

Generally, the natural language text sequences 130 provide information about the task that the agent 104 should be performing in the environment 106, e.g., about the goal that the agent 104 should be attempting to reach by acting at the time step. However, because the text is natural language text that can be generated by another agent 107, the contents of the text may underspecify the goal, may be ambiguous with respect to which goal should be reached, or may require clarification. That is, the text sequence 130 may provide insufficient information for the agent 104 to carry out the task that is intended.

The system 100 then processes a policy input that includes at least the observation image 110 and the natural language text sequence 130 using a policy neural network to select one or more actions 108 to be performed by the agent in response to the observation, e.g., in response to the image 110 and the sequence 130.

In particular, in some implementations, the agent 104 performs a single action 108 in response to each observation image 110, e.g., so that a new observation image 110 is captured after each action that the agent performs. In these implementations, the system 100 causes the agent to perform the single action, e.g., by providing instructions to the agent 104 that when executed cause the agent to perform the single action, by submitting a control input directly to the appropriate controls of the agent 104, by providing data identifying the action to a control system for the agent 104, or using another appropriate control technique.

In some other implementations, the agent 104 performs a sequence of multiple actions 108 in response to each observation image 110, e.g., so that multiple actions are performed by the agent before the next observation image 110 is captured. In these implementations, the system 100 generates a sequence of multiple actions 108 that includes a respective action 108 at multiple positions and causes the agent 104 to perform the sequence of actions 108 according to the sequence order, e.g., by performing the action at the first position first, then the action at the second position, and so on. The system 100 can cause the agent 104 to perform a given action as described above.

The policy neural network can generally have any appropriate architecture that allows the policy neural network to map a received observation that includes both an image and text to an output that defines one or more actions to be performed by the agent 104.

For example, the policy neural network can include a perceptual encoder neural network 122 that generates an encoded representation 124 for the time step and the system can then process the encoded representation 124 to generate an output that defines the one or more actions 108.

For example, the system 100 can generate the one or more actions 108 at a given time step by generating a state representation from the encoded representation 124 (also referred to as an “aggregated embedding” below) and then processing the state representation using a policy sub-neural network 126 of the policy neural network. The state representation can be the same as the encoded representation 124 or can be generated by a memory neural network, e.g., a recurrent neural network, of the policy neural network so that the state representation can incorporate information from previous environment states.

In some implementations, in addition to or instead of performing one or more actions 108 in response to an observation image 110, the system 100 can generate and provide as output an output text sequence using the encoded representation 124 at some or all of the time steps. In particular, the system 100 can process an input derived from the encoded representation 124, e.g., an input that includes the state representation, using a natural language generation neural network of the policy neural network to generate an output text sequence at the time step.

The system 100 can then generate speech representing the output text sequence and cause the interactive agent 104 to play back the speech or otherwise cause the output text sequence to be communicated to the other agent(s) 107 in the environment in order for the agent 104 to interact with the other agent(s) 107. Interacting with the other agents 107 by generating text or speech or both can allow the interactive agent 104 to ask questions of the other agent(s) 107 or otherwise obtain additional information about how to perform the desired task from the other agents 107, e.g., by prompting the other agent(s) 107 to provide additional information.

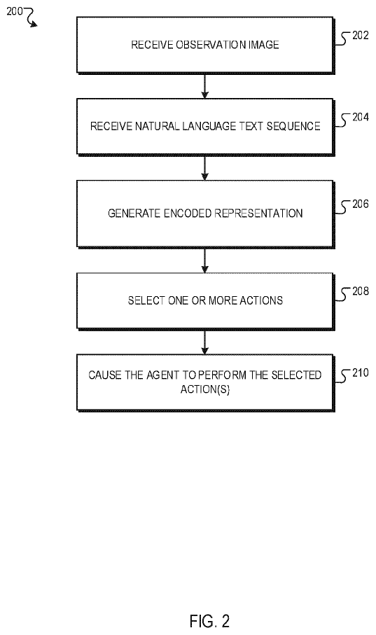

Processing input observations to generate action(s) and, optionally, output text sequences is described in more detail below with reference to FIGS. 2-4.

Prior to using the policy neural network to control the agent, a neural network training system 190 trains the policy neural network, e.g., to determine trained values of the parameters of the policy neural network, using a reward neural network 192 through reinforcement learning.

In some implementations, prior to training the policy neural network through reinforcement learning, the system 190 trains the neural networks through imitation learning, e.g., on ground truth data generated by an expert agent. The ground truth data includes a set of ground truth trajectories that each include, at a sequence of time steps, an observation that includes an observation image and a natural language text sequence, and one or more of a ground truth action and a ground truth text output. A “ground truth” action is a target action that should be performed by the agent at a given time step (or a given position in an action sequence). Similarly, a “ground truth” text output is a target text output that should be generated by the system at a given time step. For example, the ground truth actions and text outputs can be the actual actions and text outputs (respectively) performed or generated (e.g., spoken) by the expert agent at a given time step. The expert agent can be, e.g., an agent that is controlled by a human user, an agent that is controlled by an already-learned policy, or an agent that is controlled by a hard-coded, heuristic-based policy.

The reward neural network 192 is a neural network that is configured to process the observation image and the natural language text for a given time step to generate a reward output that defines a reward value that characterizes a progress of the agent in performing the task characterized by the natural language text sequence as of the time step.

For example, the reward output can be the reward value, i.e., so that the neural network 192 regresses towards the reward value. As another example, the reward output can be a probability distribution over a set of possible reward values. In this example, the system 190 can sample or greedily select one of the reward values using the probability distribution.

For example, during the reinforcement learning training, the system 190 can generate, at each time step and using the reward neural network 192, a reward in response to the action(s) performed in response to the observation at the time step, the text sequence generated as output at the time step, or both, and use the rewards to train the policy neural network using an off-policy reinforcement learning technique. In some implementations, the neural network training system 190 is separate from the action selection system 100, i.e. the action selection system 100 is not required to include a neural network training system 190.

Training using reinforcement learning is described in more detail below.

As described above, in some implementations, the system 100 first trains the policy neural network 126 through imitation learning, and then trains the policy neural network through reinforcement learning. In some other implementations, the system 100 can train the policy neural network through reinforcement learning from scratch, i.e., without any pre-training, or can pre-train some or all of the policy neural network through a different technique, e.g., an unsupervised learning technique.

Optionally, in any of the above implementations, the system 190 can use an auxiliary contrastive learning loss that employs cross-modality matching to improve the training of the policy neural network. For example, the system can pre-train the perceptual encoder 122 using the auxiliary contrastive learning loss or can train the policy neural network on a loss function that includes an imitation learning loss or a reinforcement learning loss and the auxiliary contrastive learning loss.

Cross-modality matching refers to having a discriminator neural network predict, from an encoded representation of a given observation-text sequence pair, whether the given observation and the given text sequence correspond to the same time step. An observation and a text sequence “correspond” to the same time step when the text sequence was the most recently received text sequence at the time step that the observation image was captured, e.g., when the text sequence and the observation image are temporally aligned.

In some implementations, the environment 106 is a real-world environment and the agent 104 is a mechanical agent interacting with the real-world environment, e.g. to perform one or more selected actions in the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment, that is specified by the natural language inputs received from other agent(s); or the agent may be an autonomous or semi-autonomous land, air, or sea vehicle navigating through the environment to a specified destination in the environment.

The actions may be control inputs to control a mechanical agent, e.g. a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions can include for example, position, velocity, and/or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation e.g. steering, and movement e.g., braking and/or acceleration of the vehicle.

In some implementations the environment is a simulated environment and the agent is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. As another example, the simulated environment may be a computer simulation of a real-world environment and the agent may be a simulated robot interacting with the computer simulation.

Generally, when the environment is a simulated environment, the actions may include simulated versions of one or more of the previously described actions or types of actions.

In some cases, the system can be used to control the interactions of the agent with a simulated environment, and the system can train the parameters of the neural networks (e.g. the perceptual encoder neural network 122, the policy neural network 126, and, when used, the language generation neural network) used to control the agent based on the interactions of the agent with the simulated environment. After the neural networks are trained based on the interactions of the agent with a simulated environment, the trained policy neural network can be used to control the interactions of a real-world agent with the real-world environment, e.g., to control the agent that was being simulated in the simulated environment. Training the deep neural networks based on interactions of an agent with a simulated environment (e.g., instead of a real-world environment) can avoid wear-and-tear on the agent and can reduce the likelihood that, by performing poorly chosen actions, the agent can damage itself or aspects of its environment. In some cases, the system may be partly trained using a simulation as described above and then further trained in the real-world environment.

As another example, the environment can be a video game and the agent can be an agent within the video game that interacts with one or more other agents, e.g., agents controlled by one or more human users.

As yet another example, the environment can be an augmented reality or virtual reality representation of a real-world environment, and the agent can be an entity in the representation that interacts with one or more other agents, e.g., agents controlled by one or more human users. In the case of an augmented reality environment, the observation image may comprise image data characterizing the real-world environment, including for example, an object of interest in the environment. The agent may be a software agent configured to control an electromechanical device in the real-world environment to perform one or more selected actions in the real-world environment, such as manipulating, moving, fixing and/or reconfiguring the object. The augmented reality environment may be displayed to a user, e.g. through a head-mounted display or a heads-up display.

As yet another example, the environment can be a computing environment, e.g., one or more computing devices optionally connected by a wired or wireless network, and the agent can be a software agent executing within the computing environment to interact with a user. For example, the agent can be digital assistant software that carries out tasks specified by a user within the computing environment by performing actions that control one or more of the computing devices.

FIG. 2 is a flow diagram of an example process 200 for selecting one or more actions at a time step. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system can perform the process 200 at each of multiple time steps to control the agent.

The system receives an observation image characterizing a state of the environment at the time step (step 202).

The system receives a natural language text sequence for the time step that characterizes a task being performed by the agent in the environment at the time step (step 204).

The system then processes a policy input that includes the observation image and the natural language text sequence using a policy neural network to select one or more actions to be performed by the agent in response to the observation image.

A description of an example technique for selecting the one or more actions now follows.

The system processes the observation image and the natural language text sequence using the perceptual encoder neural network to generate an encoded representation for the time step (step 206).

In some implementations, the perceptual encoder neural network includes an image embedding neural network that generates image embeddings representing the image observation, a text embedding neural network that generates text embeddings representing the image observation, and a multi-modal Transformer neural network that generates an aggregated embedding (that serves as the encoded representation).

An “embedding” as used in this specification is a vector of numeric values, e.g., floating point values or other values, having a pre-determined dimensionality. The space of possible vectors having the pre-determined dimensionality is referred to as the “embedding space.” The image embedding and the text embeddings generated by the image and text embedding neural networks are generally in the same embedding space.

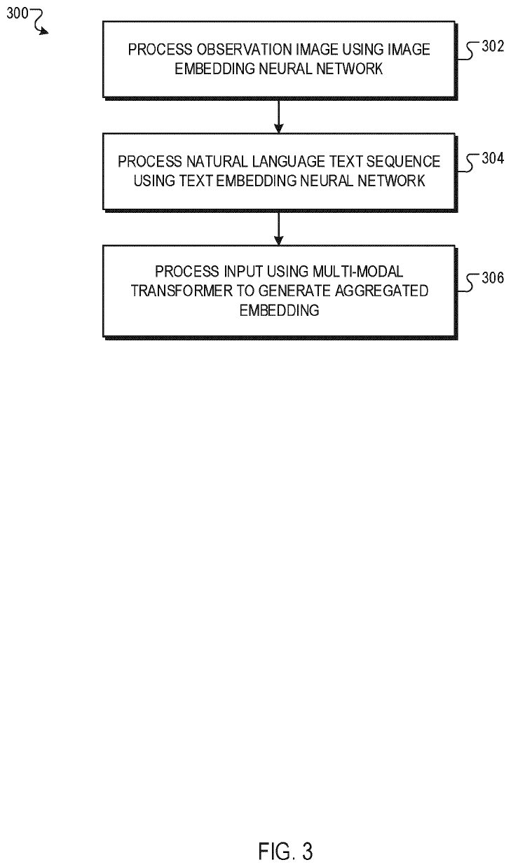

Generating an encoded representation when the perceptual encoder neural network has the above architecture is described below with reference to FIG. 3.

The system selects, using the aggregated embedding, one or more actions to be performed by the agent in response to the observation image (step 206) and causes the agent to perform the one or more selected actions (step 208).

Generally, the system processes a state representation derived from the encoded representation using a policy neural network to select the one or more actions.

That is, the system generates a state representation from the encoded representation and selects the one or more actions using the state representation, e.g., by processing the state representation using the policy neural network. In some implementations, the state representation is the same as the encoded representation. In some other implementations, the system generates the state representation by processing the encoded representation using a memory neural network, e.g., a neural network that allows the state representation to incorporate information from previous time steps. For example, the memory neural network can be a recurrent neural network, e.g., a long short-term memory (LSTM) neural network or a gated recurrent unit (GRU) neural network, to allow the state representation to incorporate information from previous time steps.

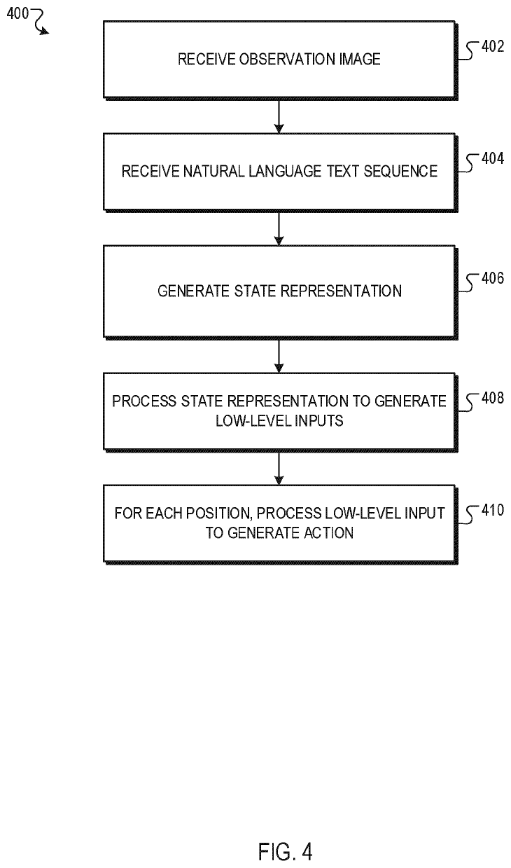

In some implementations, the system selects only a single action at each time step. In these implementations, the policy neural network can be, e.g., a multi-layer perceptron (MLP) or other feedforward neural network that generates a probability distribution over a set of actions and the system can greedily select or sample an action using the probability distribution. An alternative architecture for the policy neural network when a single action is selected is described below with reference to FIG. 4.

In some other implementations, the system selects a sequence of multiple actions at each time step. That is, the system generates a sequence of multiple actions that includes a respective action at multiple positions and causes the agent to perform the sequence of actions according to the sequence order, e.g., by performing the action at the first position first, then the action at the second position, and so on. An example of an architecture for a policy neural network that can generate a sequence of multiple actions is described below with reference to FIG. 4.

While this specification generally describes that the observations are images, in some cases the observations can include additional data in addition to image data, e.g., proprioceptive data characterizing the agent or other data captured by other sensors of the agent. In these cases, the other data can be embedded jointly with the observation image by the image embedding neural network.

FIG. 3 is a flow diagram of an example process 300 for generating an encoded representation at a time step using the perceptual encoder neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

In the example of FIG. 3, the perceptual encoder neural network includes an image embedding neural network that generates image embeddings representing the image observation, a text embedding neural network that generates text embeddings representing the image observation, and a multi-modal Transformer neural network that generates an aggregated embedding (that serves as the encoded representation).

More specifically, the system processes the observation image using an image embedding neural network to generate a plurality of image embeddings that represent the observation image (step 302). For example, the image embedding neural network can be a convolutional neural network, e.g., a ResNet or an Inception neural network, that processes the observation image to generate a feature map that includes a respective image embedding for each of a plurality of regions in the observation image. As another example, the image embedding neural network can be a Vision Transformer neural network that processes a sequence of patches from the observation image to generate a respective image embedding of each of the patches in the sequence.

The system processes the natural language text sequence using a text embedding neural network to generate a plurality of text embeddings that represent the natural language text sequence (step 304). For example, the text embedding neural network can map text tokens, e.g., words or word pieces, in the text sequence to embeddings using a learned embedding table. As another example, the text embedding neural network can be an encoder-only Transformer that processes a sequence of the text tokens to generate a respective text embedding for each of the text tokens.

The system processes an input that includes the image embeddings and the text embeddings using a multi-modal Transformer neural network to generate an aggregated embedding that serves as the encoded representation (step 306).

The Transformer neural network is referred to as “multi-modal” because it receives as input embeddings of inputs of multiple different modalities, e.g., embeddings of both natural language text and images.

In some other implementations, the perceptual encoder neural network can use a different type of multi-modal neural network, e.g., a convolutional neural network or a recurrent neural network, to generate the aggregated embedding from at least the image and text embeddings.

More specifically, the multi-modal Transformer neural network is configured to (i) apply self-attention over at least the text embeddings and the image embeddings to generate respective updated embeddings for at least the plurality of text embeddings and (ii) generate the aggregated embedding from at least the respective updated embeddings for the text embeddings.

In particular, the multi-modal Transformer includes one or more self-attention layers that each have one or more self-attention heads, e.g., so that “applying self-attention” includes processing the input through the one or more self-attention layers. That is, each self-attention layer can perform either single-head self-attention and therefore have only one attention head or can perform multi-head attention and therefore have multiple heads that each perform self-attention in parallel. The self-attention layer can then combine the outputs of the multiple heads to generate an output of the attention mechanism for the self-attention layer, e.g., by summing, averaging, or concatenating the outputs and then optionally applying a linear transformation to the result. Each self-attention layer can also perform any of a variety of other operations, e.g., layer normalization, position-wise feed-forward neural network computations, residual connection operations, and so on.

Each head of each self-attention layer can apply any of variety of self-attention mechanisms over at least inputs corresponding to the image embeddings and the text embeddings. One example of such an attention mechanism will now be described.

In this example, the input to the multi-modal Transformer neural network includes the image embeddings, the text embeddings, and one or more dedicated embeddings. A “dedicated” embedding is one that is the same at each time step and is not dependent on the observation at the time step. For example, the dedicated embedding(s) can be learned during training of the neural network or can be fixed to pre-determined values.

The multi-modal Transformer then applies self-attention to generate respective updated embeddings for the text embeddings and the dedicated embeddings without updating the image embeddings.

As one example of this, each self-attention head of each self-attention layer can be configured to receive a head input that includes (i) the image embeddings generated by the image embedding neural network and (ii) respective current embeddings for the text embeddings and the dedicated embeddings. That is, if the head is not in the first self-attention layer, the head still receives the original image embeddings but receives current embeddings for the text embedding and the dedicated embeddings that have been updated by the preceding self-attention layer(s).

The head then generates, from the respective current embeddings, a respective query corresponding to each text embedding and each dedicated embedding, e.g., by applying a learned query linear transformation to each current embedding.

The head also generates, from the image embeddings and the respective current embeddings, a respective key corresponding to each image embedding, each text embedding, and each dedicated embedding, e.g., by applying a learned key linear transformation to each embedding.

The head also generates, from the image embeddings and the respective current embeddings, a respective value corresponding to each image embedding, each text embedding, and each dedicated embedding, e.g., by applying a learned value linear transformation to each embedding.

The head then applies query-key-value attention over the respective queries, keys, and values to generate a respective initial updated embedding for each text embedding and each dedicated embedding without updating the image embeddings. That is, the head applies self-attention over the text and dedicated embeddings but only “cross-attends” to the image embeddings (because the image embeddings are only used to generate keys and values and not queries).

When there are multiple heads, the self-attention layer can then combine the respective initial updated embeddings as described above.

Self-attention and query-key-value attention are described in more detail below.

Once the multi-modal Transformer has generated the respective updated embeddings for the text embeddings and the dedicated embeddings, the Transformer can generate the aggregated embedding from the respective updated embedding.

As a particular example, the Transformer can aggregate the respective updated embeddings for the text embeddings and the dedicated embeddings to generate an initial aggregated embedding and then combine the respective updated embeddings for the dedicated embeddings with the initial aggregated embedding to generate the aggregated embedding.

The Transformer can apply any of a variety of aggregation operations, e.g., pooling operations, to the respective updated embeddings for the text embeddings and the dedicated embeddings to generate the initial aggregated embedding. For example, the Transformer can apply feature-wise mean pooling to the respective updated embeddings for the text embeddings and the dedicated embeddings to generate the initial aggregated embedding.

The Transformer can combine the respective updated embeddings for the dedicated embeddings with the initial aggregated embedding in any of a variety of ways to generate the aggregated embedding. As one example, the Transformer can concatenate each respective updated embedding for each dedicated embedding and the initial aggregated embedding.

The system then uses the aggregated embedding as the state representation.

FIG. 4 is a flow diagram of an example process 400 for generating a sequence of multiple actions at a time step. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system receives an observation image for the time step characterizing a state of the environment at the time step (step 402).

The system receives a natural language text sequence for the time step that characterizes a task being performed by the agent in the environment at the time step (step 404).

The system processes the observation image and the natural language text sequence to generate a state representation for the time step (step 406). For example, the system can generate the state representation as described above with reference to FIG. 2 or using a different set of neural networks with a different architecture.

The system generates a sequence of a plurality of actions to be performed by the agent in response to the observation image at the time step. As described above, the sequence has a respective action to be performed by the agent at each of a plurality of positions. In the example of FIG. 4, the policy neural network implements a hierarchical action selection scheme, e.g., a hierarchical control scheme, and therefore includes a high-level controller neural network and an action policy neural network.

In particular, the system processes the state representation using the high-level controller neural network to generate a respective low-level input for each position in the sequence (step 408). As a particular example, the high-level controller neural network can auto-regressively generate the respective low-level inputs for each position in the sequence after receiving as input the state representation. “Auto-regressively” generating the low-level inputs refers to generating the input for each position conditioned on the inputs for all positions that precede the position in the sequence. For example, the high-level controller neural network can be a recurrent neural network, e.g., an LSTM or a GRU, that, at the first processing time step, receives as input the state representations and, at each subsequent processing time step, receives as input the low-level input generated at the preceding processing time step.

For each position, the system processes the respective low-level input for the position using the action policy neural network to generate the action to be performed by the agent at the position in the sequence (step 410). In some implementations, each action is composed of multiple sub-actions. For example, when the agent is a robot or other mechanical agent, the sub-actions can include two or more of: a grab action that attempts to grab an object in the environment, a push/pull action that pushes or pulls an object in the environment, a rotate action that rotates one or more portions of the body of the agent, a look action that changes the orientation of the camera of the agent, and a move action that moves the agent in the environment. A control system for the agent can map these high-level actions into low-level commands, e.g., torques for the joints of the agent or other forces to be applied to portions of the body of the agent, in order to control the agent.

In these implementations, the action policy neural network can include a respective sub-network for each of the plurality of sub-actions. Thus, to process the respective low-level input for the position using the action policy neural network, for each of the plurality of sub-actions, the action policy neural network processes an input that includes the respective low-level input for the position using the sub-network for the sub-action to select a value for the sub-action for the position. For example, each sub-network can be configured to generate an output defining a probability distribution over possible values for the corresponding sub-action and the system can either greedily select the value for the sub-action or sample a sub-action using the probability distribution.

In some of these implementations, for at least one of the sub-actions, the input includes the value selected for one or more of the other sub-actions at the position. That is, the value of at least one sub-action at a given position can depend on the value of at least one other sub-action at the given position.

When only a single action is selected per time step, the policy neural network (i) can include only the respective sub-networks for each of the plurality of sub-actions and the input for each sub-network can include the state representation (instead of a low-level input) or (i) can include a feedforward high-level controller that maps the state representation to a single low-level input for a single position.

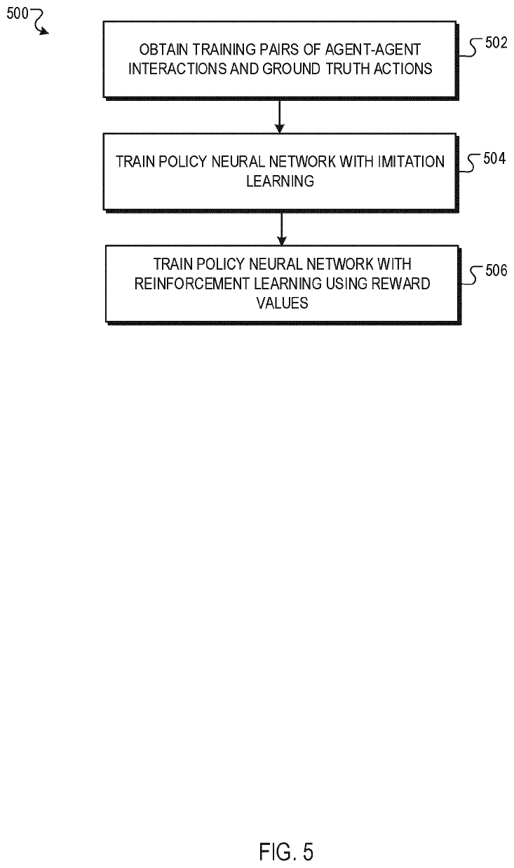

FIG. 5 is a flow diagram of an example process 500 for training a policy neural network with the output of a reward neural network using reinforcement learning. For convenience, the process 500 will be described as being performed by a system of one or more computers located in one or more locations. For example, a training system, e.g., the training system 190 of FIG. 1, appropriately programmed in accordance with this specification, can perform the process 500.

In some implementations, prior to training the neural network through reinforcement learning, the system trains the policy neural network through imitation learning, e.g., on ground truth data generated by an expert agent.

Thus, in these implementations, the system obtains ground truth data that includes a set of ground truth trajectories that each include, at a sequence of time steps, an observation that includes an observation image and a natural language text sequence, and one or more of a ground truth action or a ground truth text output (step 502). A “ground truth” action is a target action that should be performed by the agent at a given time step (or a given position in an action sequence). Similarly, a “ground truth” text output is a target text output that should be generated by the system at a given time step. For example, the ground truth actions and text outputs can be the actual actions and text outputs (respectively) performed or generated (e.g., spoken) by the expert agent at a given time step. The expert agent can be, e.g., an agent that is controlled by a human user, an agent that is controlled by an already-learned policy, or an agent that is controlled by a hard-coded, heuristic-based policy.

The system can then train the policy neural network with imitation learning on the ground truth data (step 504). For example, the system uses “teacher forcing” to score the ground truth actions and ground truth text outputs using the respective policies. That is, the system can train the policy neural network using a behavior cloning loss or other appropriate imitation learning loss. The imitation learning loss may, for example, comprise one or more terms comparing the action and/or text output generated by the system at a given time step with the ground truth action and/or text output at that time step.

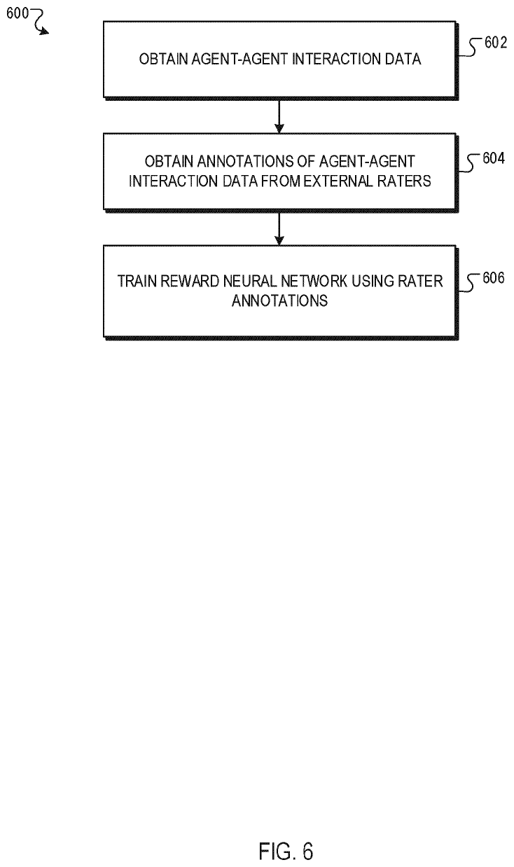

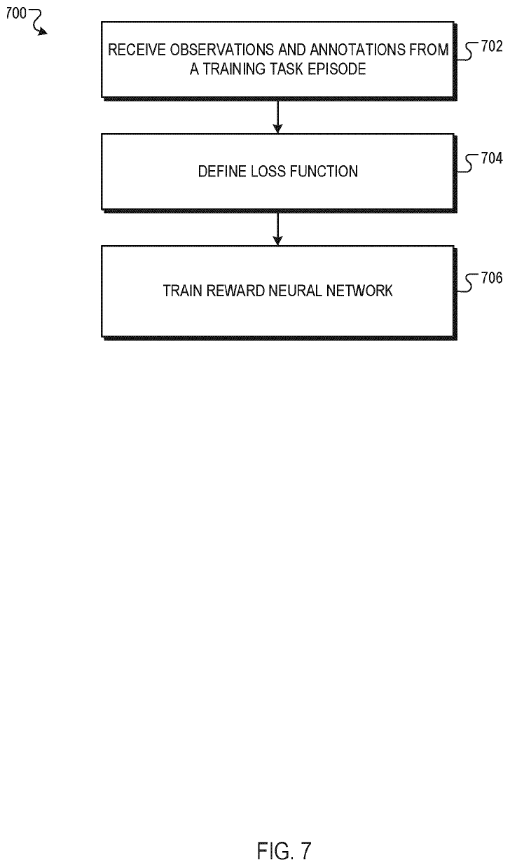

The system trains the policy neural network through reinforcement learning using reward values generated by the reward neural network (step 506). An example process of training the reward neural network to accurately estimate rewards is discussed in detail with reference to FIG. 6 and FIG. 7.

For example, when controlling the agent during reinforcement learning training, the system can generate a per-time step reward for each given time step from at least the reward value for the time step that has been generated by the reward neural network and then train the policy neural network using the per-time step rewards using any appropriate reinforcement learning algorithm, i.e., by using the per-time step rewards as the rewards that are provided as input to the reinforcement learning algorithm.

For example, for each of the plurality of time steps, the system can compute the per-time step reward based on a difference between the reward value at the time step and the reward value for a preceding time step in the sequence, e.g., the immediately preceding time step or a time step a designated number of time steps before the time step in the sequence.

The reinforcement learning algorithm can be any appropriate reinforcement learning algorithm, e.g., an actor-critic RL algorithm, a policy gradient based RL algorithm, and so on.

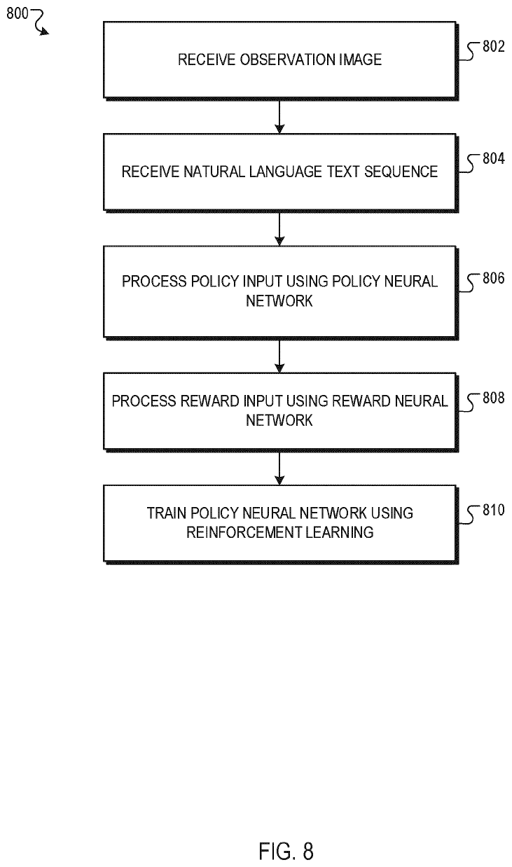

Training the policy neural network through reinforcement learning using the reward neural network will be described in more detail below with reference to FIG. 8.

FIG. 6 is a flow diagram of an example process 600 for obtaining training data to train a reward neural network. For convenience, the process 600 will be described as being performed by a system of one or more computers located in one or more locations. For example, a training system, e.g., the training system 190 of FIG. 1, appropriately programmed in accordance with this specification, can perform the process 600.

The system obtains interaction data between agents in an environment at a sequence of time steps during a plurality of training task episodes (step 602). In some implementations, in each episode, one agent sets a task (the setter) for the second agent (the solver) to complete. In some implementations, the task can be free-form, where the setter is allowed to choose the task or ask questions at will. In other implementations, the task can be prompted, where the system provides a high-level director for the setter to follow.

For example, the system may prompt the setter to provide the following instruction to the solver: “Ask the other agent to hand you something.”

In some implementations, the setter is free to give the solver new instructions at will in response to the actions of the solver.

In some implementations, the setter agent may be controlled by a setter neural network. A setter training system may train the setter neural network using imitation learning based on actions of an expert setter.

Generally, the agents are referred to as “interactive” agents because the agents interact with one or more other agents in the environment as part of interacting with the environment. The one or more other agents can include humans, other agents controlled by different computer systems, or both. The interactive agent interacts with the other agent(s) by receiving communications generated by the other agent(s) and, optionally, generating text that is communicated to the other agent(s). In some implementations, the agent(s) may be controlled by human users or by expert policies (i.e. fixed, rules-based policies or already-learned policies).

The system obtains annotation data from one or more raters (step 604). The one or more raters can be users that observe the interactions between the setter and the solver and the annotation data can include annotations that evaluate the progress of the solver towards the directive at one or more time steps within the training task episode.

For example, the system may instruct the setter to provide the instruction to the setter: “Ask the other agent to hand you something.” In this scenario, at one or more time intervals within the training task episode (the period of time after the setter delivers the instruction to the solver and before the task is either completed or aborted), the rater evaluates if the solver is performing actions that help the solver progress towards the instructed goal or not.

Generally, the annotation data for a given time step assigns a reward label to the time step.

More specifically, the annotation data assigns, to each of multiple time steps in a task episode, a respective reward label selected from a set of reward labels that includes: (i) a negative reward label that indicates that, as of the time step, the agent regressed from achieving a goal characterized in a natural language instruction for the time step, and (ii) a positive reward label that indicates that, as of the time step, the agent made progress in achieving the goal characterized in the natural language instruction for the time step. Optionally, the set also includes: (iii) a neutral reward label that indicates that the agent neither progressed nor regressed from achieving the goal.

The system trains the reward neural network using the training data (annotated agent-agent interactions from one or more raters at multiple time steps within a training task episode) (step 606).

FIG. 7 is a flow diagram of an example process 700 for training a reward neural network. For convenience, the process 700 will be described as being performed by a system of one or more computers located in one or more locations. For example, a training system, e.g., the training system 190 of FIG. 1, appropriately programmed in accordance with this specification, can perform the process 700.

The system can repeatedly perform the process 700 on different mini-batches of training data to train the reward neural network which is used to train the policy neural network through reinforcement learning.

The system trains the reward neural network to determine trained values of a set of parameters of the neural network e.g., the weights and biases of the layers of the neural network. In some implementations, the system initializes the parameters of the reward neural network using parameter values of the policy neural network that were determined by training the policy neural network through imitation learning.

For a given training task episode, the system receives a sample of observations and corresponding annotations from raters from the task episode (step 702). In particular, the sample of observations will include a sequence of observations, each sequence of observations including a respective observation for each of multiple time steps within the training task episode. Thus, for each time step, the system receives a multi-modal input, e.g., an input that includes data of multiple modalities (e.g. data types), that includes at least an observation image that characterizes the state of the environment at the time step and a natural language text sequence. Each annotation is generally associated with a respective time step (and, therefore, with the observation at the time step).

For example, a training task episode may involve the setter instructing the solver to, “Take the tissue roll and put it on the bathtub.” The raters will observe the interactions between the setter and the solver at multiple time points within the training task episode and mark key moments when the solver progressed towards the stated directive and mark key moments when the solver regressed away from the stated directive. If the solver drops the tissue roll on the floor, the rater may mark this action as a regression away from the stated directive. However, if the solver picks up the tissue roll from the floor and begins to walk towards the bathtub, the rater may mark this action as a progression towards the stated directive.

As described above, the system configures the reward neural network to output a reward value that indicates the progress of the solver towards the stated directive at a specific time point within the training task episode.

In particular, the reward values can measure the progress (also referred to as a “utility”) across a trajectory of time steps, i.e., so that the reward value for a given time step represents a utility of performing the task of a trajectory of observations up to and including the observation for the time step. For example, the utility of a trajectory that begins at the beginning of the training task episode and ends at some time “t1” indicates how much progress was made within that time interval towards the stated directive, i.e., the time interval starting the beginning of the training episode up to and including the time t1.

The system defines a loss function that depends on the reward labels for the time steps in each of multiple trajectories within the episode (step 704). The loss function can be written as

L(θ)=E_{D}[prefer(x_{≤t},x_{≤t′})ln(σ(U_{∝}(x_{≤t})−U_{θ}(x_{x≤t′})],

where x_{≤t}=(x₀, . . . , xₜ) is the sequence of observations (images and dialogue) up to time t, t and t′ are two time points on the same trajectory, D is the dataset of rater annotations, and prefer(x_{≤t}, x_{≤t′}) is an indicator function that is 1 if t′ followed t and was marked positive or −1 if t followed t′ and was marked negative.

For example, the loss function can measure differences between reward values predicted for two time steps within the same training task episode.

In this example, if both time steps in the pair have a positive reward label and no time steps that are between the time steps in the pair have a negative reward label, the loss function encourages the reward value predicted for a later time step in the pair to be greater than the reward value predicted for an earlier time step in the pair. Moreover, if both time steps in the pair have a negative reward label and no time steps that are between the time steps in the pair have a positive reward label, the loss function encourages the reward value predicted for the earlier time step in the pair to be greater than the reward value predicted for the later time step in the pair. In some implementations, any pair of time steps that does not satisfy either criterion can be ignored. In some other implementations, if both time steps in the pair have a neutral reward label and all time steps that are between the time steps in the pair have a neutral reward label, the loss function encourages the reward value predicted for the later time step in the pair to be equal to the reward value predicted for the earlier time step in the pair.

Alternatively, rather than measure differences between pairs of time steps, the loss function can measure, for each time step in each of the training episodes, an error between the reward label for the time step and the reward value for the time step.

In some implementations, the system uses one or more auxiliary losses when training the reward neural network. For example, the auxiliary losses can include an imitation learning loss that is computed using outputs generated by an auxiliary policy neural network head that generates policy outputs for controlling the agent from an intermediate output of the reward neural network.

As another example, the auxiliary loss can include a contrastive self-supervised representation learning loss. The expression for the contrastive self-supervised representation learning loss can be written as

$${L}^{CL} ( θ ) = - \frac{1}{B} {\sum }_{n = 1}^{B} {\sum }_{t = 0}^{T} [ ln {D}_{θ} ( {o}_{n , t}^{V} , {o}_{n , t}^{L} ) + ln ( 1 - {D}_{θ} ( {o}_{n , t}^{V} , {o}_{SHIFT ( n ) , t}^{L} ) ) ] ,$$

where B is the batch size for the training step, SHIFT(n) is the n-th index after a modular shift of integers: 1->2, 2->3 . . . , B->1, and superscripts denote the modality (V for vision, L for language). The observation sequences are denoted as o, and D_{θ} denotes the processing of observations through the perceptual encoder.

Similarly, the system may define the auxiliary loss to include a cross-modality matching loss that uses outputs generated by the reward neural network.

The system trains the reward neural network on loss function (step 706). To train the reward neural network, the system computes the gradient of the loss function by evaluating the loss function at different time steps within the training episode. The system then updates the parameters of the reward neural network, e.g., by applying an optimizer, e.g., Adam, AdamW, Adafactor, and so on, to the gradient.

FIG. 8 is a flow diagram of an example process 800 for training a policy neural network through reinforcement learning using reward values generated from a reward neural network. For convenience, the process 800 will be described as being performed by a system of one or more computers located in one or more locations. For example, a training system, e.g., the action selection system 100 of FIG. 1, appropriately programmed in accordance with this specification, can perform the process 800.

The system receives an observation image for the time step characterizing a state of the environment at the time step (step 802).

The system receives a natural language text sequence for the time step that characterizes a task being performed by the agent in the environment at the time step (step 804).

The system processes a policy input that includes the observation image and the natural language text sequence using the policy neural network to generate an output that determines the one or more actions (step 806) that should be taken by the agent acting in the environment as described above with reference to FIG. 1-3.

The system processes a reward input that includes the observation image and the natural language text sequence using a reward neural network (step 808). As described above, the system trains the reward neural network so that the reward neural network is configured to process the observation image and the natural language text to generate a reward output that defines a reward value that characterizes a progress of the agent in performing the task characterized by the natural language text sequence as of the time step.

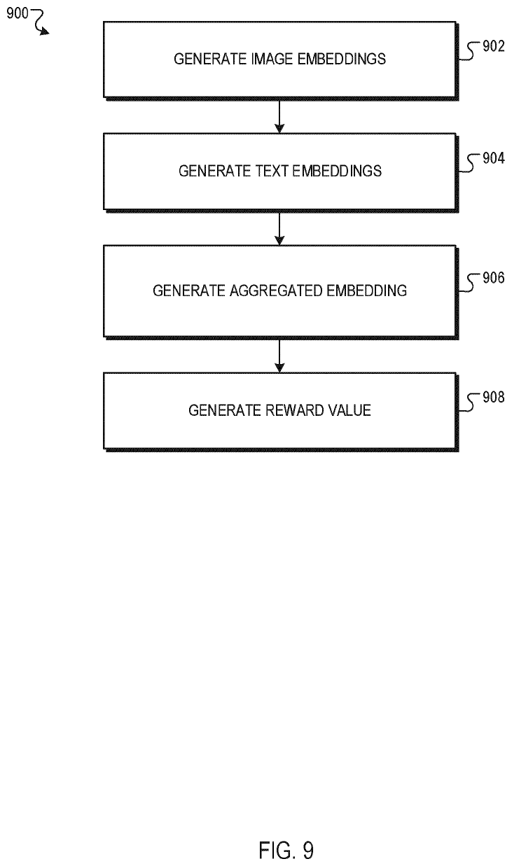

An example architecture for the reward neural network is described in more detail below with reference to FIG. 9.

The system trains the policy neural network using a reinforcement learning technique (step 810).

FIG. 9 is a flow diagram of an example process 900 for generating a reward value using a reward neural network. For convenience, the process 900 will be described as being performed by a system of one or more computers located in one or more locations. For example, a training system, e.g., the reward neural network training system 190 of FIG. 1, appropriately programmed in accordance with this specification, can perform the process 900.

The reward neural network can generally have any appropriate architecture that allows the reward neural network to map an image and text to a scalar reward value.

In particular, in the example of FIG. 9, the reward neural network has the same architecture as the policy neural network, but with the policy head (sub-neural network) replaced with a reward head (sub-neural network). In some cases, the parameters of components that are shared between the policy neural network and the reward neural network can be initialized using, e.g., values of parameters determined by pre-training the policy neural network through imitation learning.

The system uses an image embedding neural network to generate a plurality of image embeddings that represent the observation image (step 902), e.g., as described above.

The system processes an input that includes the natural language text sequence using a text embedding neural network to generate a plurality of text embeddings that represent at least the natural language text sequence (step 904), e.g., as described above.

The system processes an input that includes the image embeddings and the text embeddings using a multi-modal neural network to generate an aggregated embedding (step 906).

The multi-modal neural network can generally have any appropriate architecture.

As one example, the multi-modal neural network can be a multi-modal Transformer neural network that is configured to (i) apply self-attention over at least the text embeddings and the image embeddings to generate respective updated embeddings for at least the plurality of text embeddings and (ii) generate the aggregated embedding from at least the respective updated embeddings for the text embeddings.

As described above, the multi-modal Transformer neural network includes one or more self-attention layers that each have one or more self-attention heads, where applying self-attention comprises processing the input through the one or more self-attention layers.

As described above, in some cases, the input to the multi-modal Transformer neural network includes the image embeddings, the text embeddings, and one or more dedicated embeddings.

As described above, applying self-attention can include generating respective updated embeddings for the text embeddings and the dedicated embeddings without updating the image embeddings.

In this example, each self-attention head of each self-attention layer is configured to: receive a head input comprising (i) the image embeddings generated by the image embedding neural network and (ii) respective current embeddings for the text embeddings and the dedicated embeddings; generate, from the respective current embeddings, a respective query corresponding to each text embedding and each dedicated embedding; generate, from the image embeddings and the respective current embeddings, a respective key corresponding to each image embedding, each text embedding, and each dedicated embedding; generate, from the image embeddings and the respective current embeddings, a respective value corresponding to each image embedding, each text embedding, and each dedicated embedding; and apply query-key-value attention over the respective queries, keys, and values to generate a respective initial updated embedding for each text embedding and each dedicated embedding without updating the image embeddings.

In some examples, to generate the aggregated embedding, the system aggregates the respective updated embeddings for the text embeddings and the dedicated embeddings to generate an initial aggregated embedding; and combining the respective updated embeddings for the dedicated embeddings with the initial aggregated embedding to generate the aggregated embedding.

In some examples, the system combines each respective updated embedding and the initial aggregated embedding by concatenating each respective updated embedding and the initial aggregated embedding.

More details on the operation of a multi-modal Transformer are described above with reference to the description of the policy neural network.

The system then processes an input that includes the aggregated embedding using a reward neural network head to generate the reward value (step 908).

In some examples, the reward neural network head generates a state representation from the aggregated embedding and processes the state representation using one or more neural network layers to generate the reward output. For example, the head can generate the state representation by processing the aggregated embedding using a memory neural network.

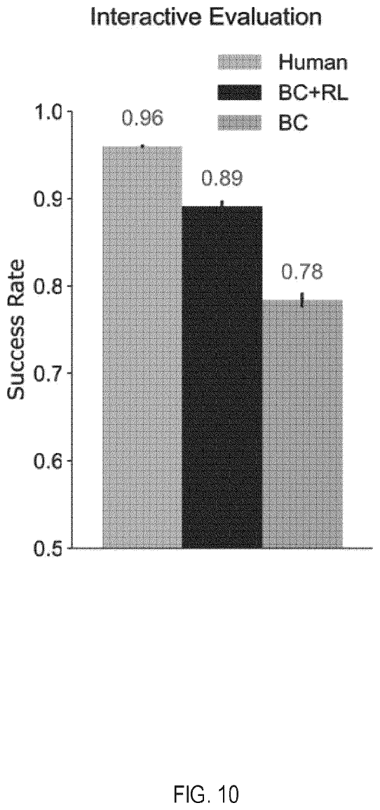

As described above, the memory neural network can be a recurrent neural network. FIG. 10 shows a comparison of the performance of different versions of the policy neural network.

In particular FIG. 10 shows the performance of an agent controlled by a policy neural network trained using imitation learning (behavioral cloning, denoted as BC), imitation learning fine-tuned with reinforcement learning (BC+RL), and compared to an agent controlled by a human performing the same actions. In particular, the plot in FIG. 10 shows the improved performance between the agent controlled by the policy neural network trained purely on imitation learning compared to the agent controlled by the policy neural network trained with both imitation learning and reinforcement learning from a reward neural network. The agent controlled by the policy neural network that is trained with both imitation and reinforcement learning is closer to human performance as compared to the agent controlled by the policy neural network that is only trained with imitation learning. The agent controlled by the policy neural network trained with imitation and reinforcement learning achieved a success rate of 89%, whereas the agent controlled by the policy neural network trained with imitation learning alone achieved a success rate of 78%. This is compared with a success rate of 96% for humans solving the same tasks.

The agents in this evaluation were evaluated by expert raters across a range of tasks that belong to a class of tasks with well-defined instructions and task completion. For example, common tasks include counting, identifying colors, lifting objects, and positioning one object next to another. Raters can easily evaluate whether an agent succeeds at completing these tasks with clear objectives.

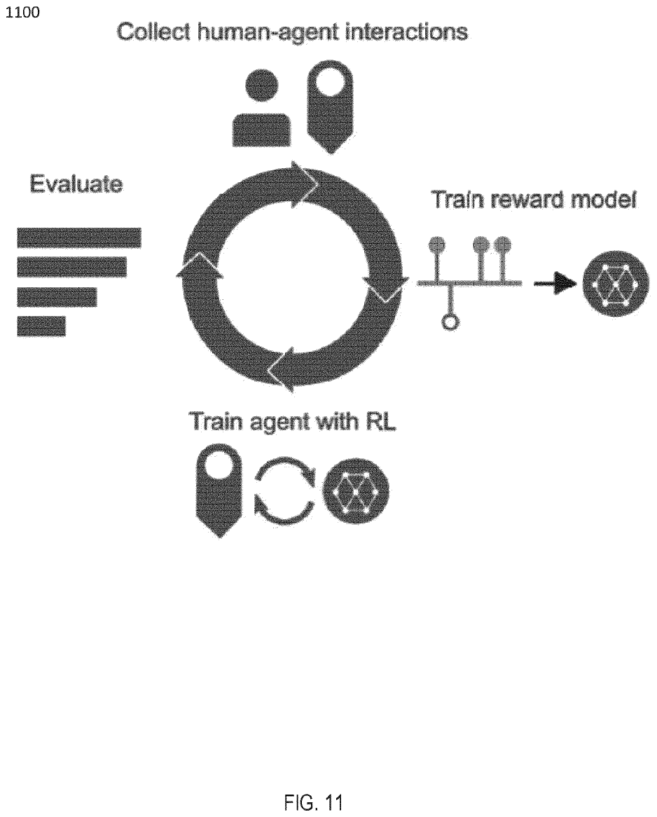

FIG. 11 shows an example process of improving a policy neural network with reinforcement learning using outputs of a reward model. For convenience, the process will be described as being performed by a system of one or more computers located in one or more locations.

The process can be repeated over multiple training iterations. In each iteration, the system deploys an agent to interact with humans and collects feedback on its behavior from raters. The human-agent interactions can be of a set of multiple prompts including language game prompts. For example, the system can provide the agent a prompt that consists of a textual cue indicating the general type of instruction, combined with a modifier that stipulates additional constraints that the human's instruction must satisfy.

The system can employ a variety of language games to form the basis of the human-agent interaction that can include instruction-following tasks such as the following: “Ask the other player to touch an object using another object”, “Ask the other player to perform an activity of your choice.”, “Ask the other player to hand you something, which you then hold.”. or “Ask the other player to stand in some position relative to you.” Alternatively or in addition, the language games can include question-answering tasks such as the following: “Ask the other player a yes/no question about something in the room.”, “Ask the other player to describe where something is.”, “Ask the other player to count something.”, “Ask the other player to say what they are looking at or noticing right now.”, or “Ask a question about the color of something.”. As another type of language game, the human-agent interaction can involve tasks that aim to modify the agent's behavior, such as, “Refer to objects by colour.”,

“Refer to location by colour.”, “Refer to objects by location.”, or “Use shape words. Try to use shape words like: circular, rectangular, round, pointy, long.”.

The system updates the reward neural network by training on the data collected by the human-agent interaction data with feedback from raters.

The policy network can be continuously updated as the reward neural network is updated with more human-agent interaction data. The system can evaluate the outputs of the policy network trained with reinforcement learning using the reward model outputs. As more data is collected from human-agent interactions, the reward neural network is updated, and the policy neural network is re-trained using the updated reward neural network.

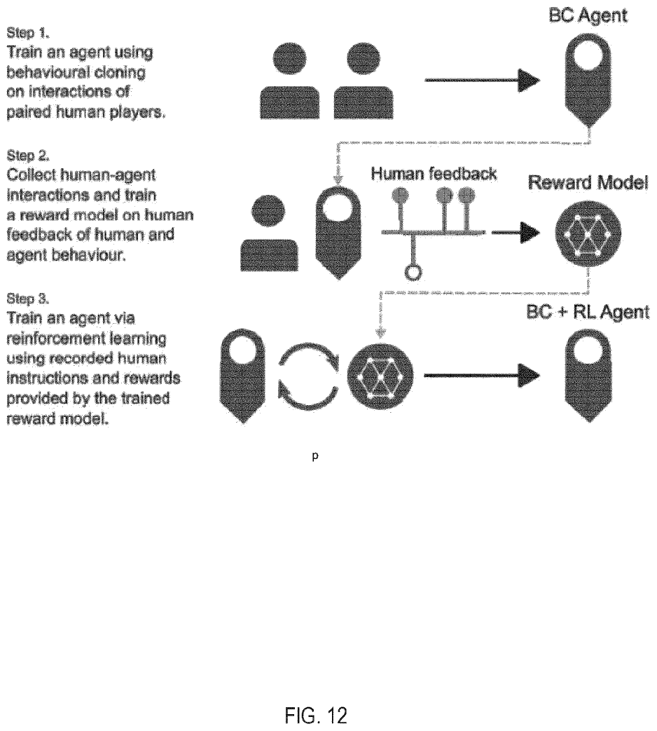

FIG. 12 shows a diagram of an example process training a policy neural network, training a reward neural network, and training the policy neural network on the reward neural network using reinforcement learning.

The policy neural network is first trained using imitation learning, often referred to as behavioral cloning, which frames behavior copying as a sequence learning problem. The policy neural network trained with imitation learning creates agents that capture a diversity of human interaction behavior.

The system collects human-agent interactions as described in relation to FIG. 11. The human-agent interactions between the policy neural network trained with imitation learning and human agents. The human-agent interactions are evaluated by raters as described in relation to FIG. 6.

The reward neural network is then trained on the human-agent interaction data annotated by raters as described in relation to FIG. 7.

The outputs of the reward neural network are then used to train the policy neural network using reinforcement learning as described in relation to FIG. 8.

The system started by training an agent via behavioural cloning (BC) from a dataset of human-human interactions. Then, we collected a dataset of human-agent interactions and, for a subset of episodes, asked humans to provide judgments of progress towards or regression from the human-instructed goal. Next, we trained a network to model this human feedback and obtained a reward model. Finally, we used the reward model to train a new agent that combines behavioural cloning and reinforcement learning from human feedback (BC+RL).

In brief, we trained an imitation-based agent via behavioural cloning (BC) from our dataset of human-human interactions, also following the cited method. In these human-human interactions, one player (the setter) set tasks for a second player (the solver), who performed the tasks. These tasks involved mobile manipulation and question-answering or combinations thereof. Imitation learning produced an agent that was often competent in the human interactions. We then asked humans to interact with this imitation-trained agent. Human raters annotated a subset of these interactions offline by watching videos from the perspective of the solver agent. The raters marked discrete moments where the agent made progress towards or regressed from the goal. We modelled these annotated data, obtaining a “reward model” that captures the details of human feedback. Finally, we used reinforcement learning to train the agent to improve with respect to the learned reward model's output

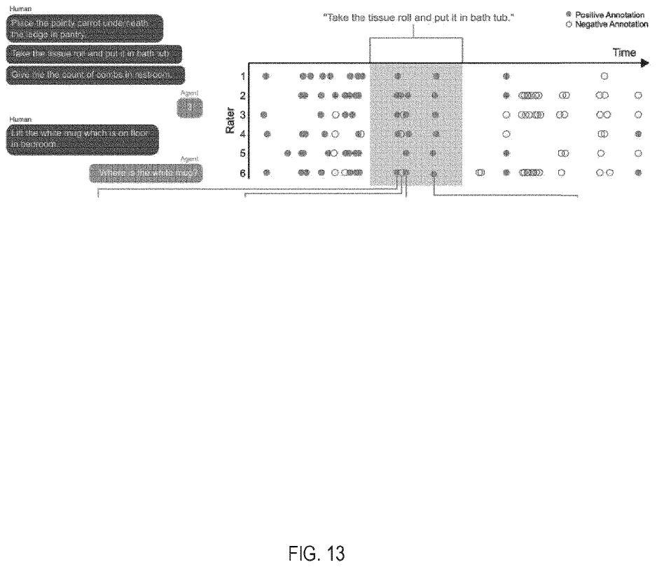

FIG. 13 shows an example of the data collected for training the reward neural network.

An example episode within the rater feedback dataset is shown. The original dialogue between the human and the agent is shown on the left, next to a plot of the feedback that 6 human raters gave to the particular episode. Positive and negative feedback marks are represented by filled green and empty red dots, respectively. While 6 ratings were collected for the episode, most of the data was annotated by 1 rater (1.2 on average).

The figure shows an example episode annotated by several raters. As shown in the zoomed-in segment, where the human setter asked the agent solver to “Take the tissue roll and put it on the bathtub”, raters marked as positive key moments that place the agent closer to solving the task, like picking up the object and placing it in the correct place. They also placed negative marks at times of regression, like dropping the object on the floor. In addition to collecting feedback on human-agent interactions, we also asked for human feedback on human-human and human-agent-human interactions. Human-human interactions typically demonstrate long sequences of desirable behaviour, and human-agent-human interactions typically demonstrate mistakes in agent behaviour and associated corrections of the mistakes. In total, we collected 5,104,000 individual feedback marks over 364,690 episodes.

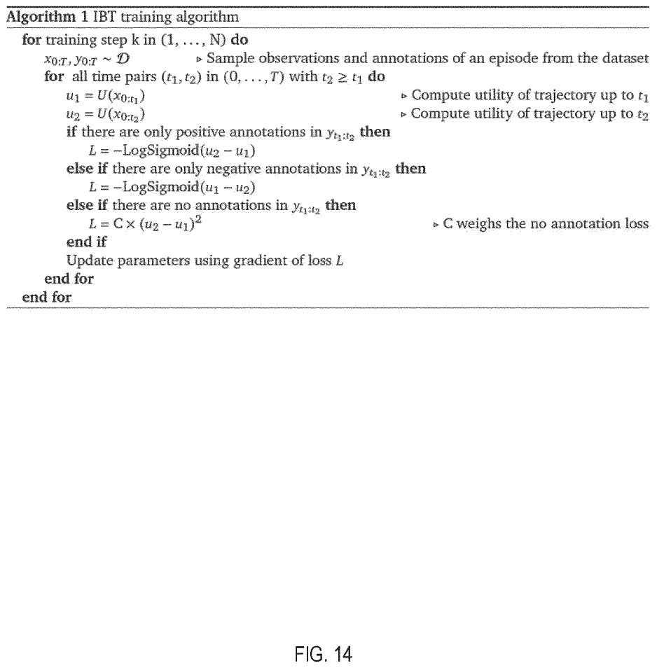

FIG. 14 shows an example pseudo-code algorithm for implementing an “Inter-temporal Bradley-Terry” model to train the reward neural network. The loss function at each training step is defined by the annotation of the interaction by the human rater, which depends on whether the human rater rated the interaction positively or negatively relative to the progress towards the stated goal. The system can use reinforcement learning to optimize the relative change in utility during the episode U(xT)−U(x0). Given this specification, the per-step reward was given by r=U(xt+1)−U(xt), where the utility U(xt) at each time step was provided by the IBT reward model.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow or JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for training a policy neural network for controlling an agent interacting with an environment, the method comprising:
at each of a plurality of time steps during a task episode:
obtaining an observation for the time step, the observation comprising:
an image characterizing a state of the environment at the time step; and
a natural language text sequence for the time step that characterizes a task being performed by the agent in the environment at the time step;
processing a policy input comprising the observation image and the natural language text sequence using the policy neural network to select one or more actions to be performed by the agent in response to the observation image; and
processing a reward input comprising the observation image and the natural language text sequence using a reward neural network, wherein the reward neural network is configured to process the observation image and the natural language text to generate a reward output that defines a reward value that characterizes a progress of the agent in performing the task characterized by the natural language text sequence as of the time step; and
training the policy neural network through reinforcement learning using the respective reward values for the plurality of time steps.

2. The method of claim 1, further comprising:
prior to training the policy neural network through reinforcement learning, training the policy neural network through imitation learning on data characterizing interactions between a plurality of agents in the environment.

3. The method of claim 1, wherein the reward neural network is configured to generate reward values that represent a utility to performing the task of a trajectory of observations up to and including the observation for the time step.

4. The method of claim 1, wherein training the policy neural network through reinforcement learning using the respective reward values for the plurality of time steps comprises:
for each of the plurality of time steps, computing a per-time step reward based on a difference between the reward value at the time step and the reward value for a preceding time step; and
training the policy neural network through reinforcement learning using the respective per-time step rewards for the plurality of time steps.

5. The method of claim 1, wherein the reward input further comprises a reward value generated for a preceding time step.

6. The method of claim 1, wherein the reward input further comprises a natural language output generated by the agent at a preceding time step.

7. The method of claim 1, wherein the reward output is the reward value.

8. The method of claim 1, wherein the reward output comprises a probability distribution over a set of possible reward values.

9. The method of claim 1, wherein the reward neural network has been trained on training data that includes, for each of one or more time steps in each of a plurality of training task episodes, a respective reward label selected from a set of reward labels that includes:
(i) a negative reward label that indicates that, as of the time step, the agent regressed from achieving a goal characterized in a natural language instruction for the time step, and
(ii) a positive reward label that indicates that, as of the time step, the agent made progress in achieving the goal characterized in the natural language instruction for the time step.

10. The method of claim 9, wherein the set also includes:
(iii) a neutral reward label.

11. The method of claim 9, wherein the reward neural network has been trained on the training data on a loss function that measures differences between reward values predicted for two time steps within the same training task episode.

12. The method of claim 11, wherein, for a given pair of time steps within the same training task episode:
if both time steps in the pair have a positive reward label and no time steps that are between the time steps in the pair have a negative reward label, the loss function encourages the reward value predicted for a later time step in the pair to be greater than the reward value predicted for an earlier time step in the pair; and
if both time steps in the pair have a negative reward label and no time steps that are between the time steps in the pair have a positive reward label, the loss function encourages the reward value predicted for the earlier time step in the pair to be greater than the reward value predicted for the later time step in the pair.

13. The method of claim 12, wherein, for the given pair of time steps:
if both time steps in the pair have a neutral reward label and all time steps that are between the time steps in the pair have a neutral reward label, the loss function encourages the reward value predicted for the later time step in the pair to be equal to the reward value predicted for the earlier time step in the pair.

14. (canceled)

15. The method of claim 9, wherein processing a reward input comprising the observation image and the natural language text sequence using a reward neural network comprises:
using an image embedding neural network to generate a plurality of image embeddings that represent the observation image;
processing an input comprising the natural language text sequence using a text embedding neural network to generate a plurality of text embeddings that represent at least the natural language text sequence;
processing an input comprising the image embeddings and the text embeddings using a multi-modal neural network to generate an aggregated embedding; and
processing an input comprising the aggregated embedding using a reward neural network head to generate the reward value.

16. The method of claim 15, wherein the multi-modal neural network is a multi-modal Transformer neural network that is configured to (i) apply self-attention over at least the text embeddings and the image embeddings to generate respective updated embeddings for at least the plurality of text embeddings and (ii) generate the aggregated embedding from at least the respective updated embeddings for the text embeddings, wherein the input to the multi-modal Transformer neural network comprises the image embeddings, the text embeddings, and one or more dedicated embeddings.

17. The method of claim 16, wherein the multi-modal Transformer neural network comprises one or more self-attention layers that each have one or more self-attention heads, and wherein applying self-attention comprises processing the input through the one or more self-attention layers.

18. (canceled)

19. The method of claim 17, wherein applying self-attention comprises generating respective updated embeddings for the text embeddings and the dedicated embeddings without updating the image embeddings.

20. The method of claim 19, wherein each self-attention head of each self-attention layer is configured to:
receive a head input comprising (i) the image embeddings generated by the image embedding neural network and (ii) respective current embeddings for the text embeddings and the dedicated embeddings;
generate, from the respective current embeddings, a respective query corresponding to each text embedding and each dedicated embedding;
generate, from the image embeddings and the respective current embeddings, a respective key corresponding to each image embedding, each text embedding, and each dedicated embedding;
generate, from the image embeddings and the respective current embeddings, a respective value corresponding to each image embedding, each text embedding, and each dedicated embedding; and
apply query-key-value attention over the respective queries, keys, and values to generate a respective initial updated embedding for each text embedding and each dedicated embedding without updating the image embeddings.

21. The method of claim 20, wherein generating the aggregated embedding comprises:
aggregating the respective updated embeddings for the text embeddings and the dedicated embeddings to generate an initial aggregated embedding; and
combining the respective updated embeddings for the dedicated embeddings with the initial aggregated embedding to generate the aggregated embedding, wherein the combining comprises concatenating each respective updated embedding and the initial aggregated embedding.

22. (canceled)

23. The method of claim 15, wherein processing an input comprising the aggregated embedding using a reward neural network head to generate the reward output comprises:
generating a state representation from the aggregated embedding, the generating comprising processing the aggregated embedding using a memory neural network, wherein the memory neural network is a recurrent neural network; and
processing the state representation using one or more neural network layers to generate the reward output.

24. (canceled)

25. (canceled)

26. The method of claim 15, wherein the reward input further comprises a natural language output generated by the agent at a preceding time step, wherein the input to the text embedding neural network further comprises the natural language output and the text embeddings represent the natural language text sequence and the natural language output.

27. The method of claim 1, wherein the natural language text sequence is generated from a natural language text sequence that is generated based on a corresponding natural language text sequence from a corresponding time step in a training task episode.

28. The method of claim 1, wherein the natural language text sequence is generated by a setter agent in the environment, the setter agent controlled using a setter neural network, wherein the setter neural network has been trained to imitate an expert setter agent through imitation learning.

29. (canceled)

30. (canceled)

31. The method of claim 15, wherein the reward neural network has been trained on an overall loss function that includes (i) a loss function that is based on the reward labels and (ii) one or more auxiliary losses comprising an imitation learning loss that is computed using an output generated by an auxiliary policy neural network head that generates policy outputs for controlling the agent and/or a contrastive self-supervised representation learning loss.

32. (canceled)

33. (canceled)

34. The method of claim 31, wherein the one or more auxiliary losses include a cross-modality matching loss that uses outputs generated by the multi-modal neural network.

35. The method of claim 2, wherein at least some parameter values of the reward neural network were initialized using parameter values of the policy neural network that were determined by training the policy neural network through imitation learning.

36. The method of claim 1, wherein training the policy neural network through reinforcement learning using the respective reward values for the plurality of time steps comprises:
training the policy neural network through reinforcement learning and through imitation learning on an imitation learning data set.

37. (canceled)

38. (canceled)

39. (canceled)

40. The method of claim 1, wherein the environment is a computing environment and the agent is a software agent executing within the computing environment to control, by performing actions selected by the trained policy neural network, one or more computing devices to carry out a task specified by a user interacting with the software agent.

41. A system comprising one or more computers and one or more storage devices storing instructions that when executed by the one or more computers cause the one more computers to perform the operations, the operations comprising:
at each of a plurality of time steps during a task episode:
obtaining an observation for the time step, the observation comprising:
an image characterizing a state of the environment at the time step; and
a natural language text sequence for the time step that characterizes a task being performed by the agent in the environment at the time step;
processing a policy input comprising the observation image and the natural language text sequence using the policy neural network to select one or more actions to be performed by the agent in response to the observation image; and
processing a reward input comprising the observation image and the natural language text sequence using a reward neural network, wherein the reward neural network is configured to process the observation image and the natural language text to generate a reward output that defines a reward value that characterizes a progress of the agent in performing the task characterized by the natural language text sequence as of the time step; and
training the policy neural network through reinforcement learning using the respective reward values for the plurality of time steps.

42. One or more computer storage media storing instructions that when executed by one or more computers cause the one more computers to perform operations, the operations comprising:
at each of a plurality of time steps during a task episode:
obtaining an observation for the time step, the observation comprising:
an image characterizing a state of the environment at the time step; and
a natural language text sequence for the time step that characterizes a task being performed by the agent in the environment at the time step;
processing a policy input comprising the observation image and the natural language text sequence using the policy neural network to select one or more actions to be performed by the agent in response to the observation image; and
processing a reward input comprising the observation image and the natural language text sequence using a reward neural network, wherein the reward neural network is configured to process the observation image and the natural language text to generate a reward output that defines a reward value that characterizes a progress of the agent in performing the task characterized by the natural language text sequence as of the time step; and
training the policy neural network through reinforcement learning using the respective reward values for the plurality of time steps.
